(19) United States
(12) Patent Application Publication
(10) Pub. No.: US 2025/0275617 A1
(43) Pub. Date: Sep. 4, 2025

(54) COMPUTING DEVICE CASE WITH REMOVABLE KICKSTAND

(71) Applicant: Microsoft Technology Licensing, LLC, Redmond, WA (US)

(72) Inventor: Michael Gordon OLDANI, Redmond, WA (US)

(73) Assignee: Microsoft Technology Licensing, LLC, Redmond, WA (US)

(21) Appl. No.: 18/857,281

(22) PCT Filed: Apr. 12, 2023
(86) PCT No.: PCT/US2023/018261

§ 371 Date: Oct. 16, 2024

(30) Foreign Application Priority Data
Apr. 20, 2022 (NL) 2031645

(51) Int. Cl. A45C 11/00

(52) U.S. Cl. CPC A45C 11/003; A45C 11/002; A45C 2200/15

(57) ABSTRACT

A case for a computing device comprises a removable kickstand. In one example, a case substrate comprises a friction clip mount. A kickstand is removably and rotatably coupled to the case substrate via a friction clip that partially surrounds the friction clip mount. The friction clip defines an opening through which the friction clip mount is removable from the friction clip to thereby separate the kickstand from the case substrate.

### BACKGROUND

Some computing devices, such as a tablet computing device, utilize a case that includes a kickstand. The kickstand is movable to support at least a portion of the device, such as by propping up a display portion of the tablet computing device on a tabletop.

### SUMMARY

According to one aspect of the present disclosure, a case is provided for a computing device. The case comprises a case substrate that includes a friction clip mount. A removable kickstand includes a friction clip that is removably coupled to the friction clip mount. The friction clip defines an opening that partially surrounds through the friction clip mount to rotatably couple the kickstand to the case substrate. The friction clip is removeable from the friction clip mount via the opening to thereby separate the kickstand from the case substrate.

According to another aspect of the present disclosure, a case for a computing device comprises a removable kickstand comprising a friction clip mount. A case substrate comprises a friction clip that is removably coupled to the friction clip mount, with the friction clip defining an opening that partially surrounds the friction clip mount to rotatably couple the kickstand to the case substrate. The friction clip is removeable from the friction clip mount via the opening to thereby separate the kickstand from the case substrate. The case substrate further comprises a surface relief feature operatively configured to disengage the friction clip from the friction clip mount when the kickstand is rotated to an angle greater than a disengagement threshold angle between the kickstand and the case substrate.

In another aspect of the present disclosure, a method for detaching a kickstand from a case for a computing device is disclosed. The kickstand is removably and rotatably coupled to a case substrate of the case via a friction clip that partially surrounds a friction clip mount of the case substrate. The method includes rotating the kickstand to form a rotated angle between the kickstand and the case substrate of greater than a disengagement threshold angle and, at least at the rotated angle, leveraging the kickstand against at least a portion of the case substrate to force the friction clip mount to separate from the friction clip through an opening in the friction clip.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of a case for a computing device according to an example embodiment of the subject disclosure.

FIG. 2 shows an exploded view of the case of FIG. 1 with the kickstand detached from the case substrate.

FIG. 3 shows a cross-sectional view of a portion of the case of FIG. 1.

FIG. 4 shows the same cross-sectional view with the kickstand of the case in a closed configuration.

FIG. 5 shows the same cross-sectional view with the kickstand rotated to an angle greater than a disengagement threshold angle.

FIG. 6 shows an enlarged view of a friction clip and a friction clip mount that can be used in the case of FIG. 1.

FIG. 7 shows another view of the case of FIG. 1.

FIG. 8 shows another cross-sectional view of the portion of the case depicted in FIGS. 3-5 with the kickstand being rotated towards the closed configuration.

FIG. 9 shows another example of a case for a computing device according to an example of the present disclosure.

FIG. 10 shows an exploded view of the case of FIG. 9 with the kickstand detached from the case substrate.

FIG. 11 shows a cross-sectional view of a portion of the case of FIG. 9.

FIG. 12 shows the same cross-sectional view with the kickstand rotated to an open configuration.

FIG. 13 shows the same cross-sectional view with the kickstand rotated to an angle greater than a disengagement threshold angle.

FIG. 14 is a flowchart illustrating a method for detaching a kickstand removably and rotatably coupled to a case substrate for a computing device via a friction clip that partially surrounds a friction clip mount of the case substrate according to an example embodiment of the subject disclosure.

### DETAILED DESCRIPTION

As introduced above, some computing devices utilize a case that includes a kickstand. The kickstand is operatively configured to support at least a portion of the device. For example, some tablet computing devices include a kickstand that rotates to an angled position with respect to the device's display and allows the device to stand at an angled position on a surface, such as a tabletop. However, because kickstands are rotatable and protrude from a housing of the computing device, they are subject to potential misuse, unintended over-rotations by inattentive users, and accidental drops or other impacts. These potentially damaging use cases are more common in rugged use environments, such as outdoors and in industrial environments, and with certain groups of users such as children and persons with limited dexterity. In these cases, damage to the kickstand and/or one or more hinges coupling the kickstand to the device can result.

To address one or more of these issues, a case that includes a rotatable and removable kickstand is provided for a computing device. The case includes a case substrate comprising a friction clip mount. The kickstand comprises friction clip that is removably coupled to a friction clip mount. The friction clip defines an opening that partially surrounds the friction clip mount to rotatably couple the kickstand to the case substrate. When connected, the friction clip cooperates with the friction clip mount to provide sufficient friction to enable the kickstand to support at least a portion of the computing device at different angles. Advantageously and as described in more detail below, friction clip is removeable from the friction clip mount via the opening to thereby separate the kickstand from the case substrate. More particularly, the friction clip is configured to disengage from the friction clip mount in response to rotation of the kickstand beyond a disengagement threshold angle, thereby allowing the kickstand to safely detach from the case substrate without damaging the kickstand or the substrate.

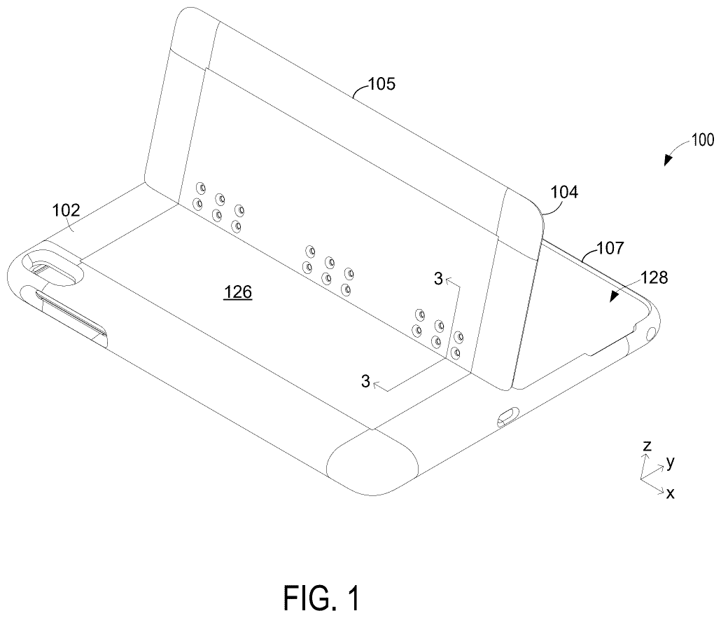

FIG. 1 shows a rear perspective view of one example of a case 100 for a computing device, such as a laptop computing device, a tablet computing device, or a mobile computing device (e.g., a smartphone), according to examples of the present disclosure. It will also be appreciated that the case 100 may be configured for use with any other suitable computing device. Other examples of suitable computing devices include, but are not limited to, a home-entertainment computing device, a network computing device, and a gaming device.

In some examples, the case 100 is an integral chassis of the computing device that houses internal components of the device. In other examples, the case 100 is a removable external case that at least partially surrounds a chassis of the computing device.

The case 100 comprises a case substrate 102 that includes an external surface in the form of rear surface 126. In the present example, the case 100 is configured to contain a tablet computing device (not shown) such that the display of the device faces away from rear surface 126. The case 100 and case substrate 102 are configured to protect an enclosed computing device from impacts, scratches, drops, and other forces that could potentially damage the device. In different examples, the case 100 is fabricated from a thermoplastic polymer, such as polycarbonate or acrylonitrile butadiene styrene (ABS), one or more elastomers such as silicone rubbers, combinations of the foregoing, and/or any other suitable materials.

The case 100 also includes a kickstand 104 that is rotatably coupled to the case substrate 102, as described further below. The kickstand 104 is operatively configured to support at least a portion of the device, such as by propping up the device by placing the rear edge 105 of the kickstand and a bottom edge 107 of the case 100 on a surface such as a tabletop. This may enable a user to interact with the device more easily as compared to the device laid flat on the surface. For example, leaning a tablet computing device against a kickstand may allow users to view displayed content from a distance without holding the device.

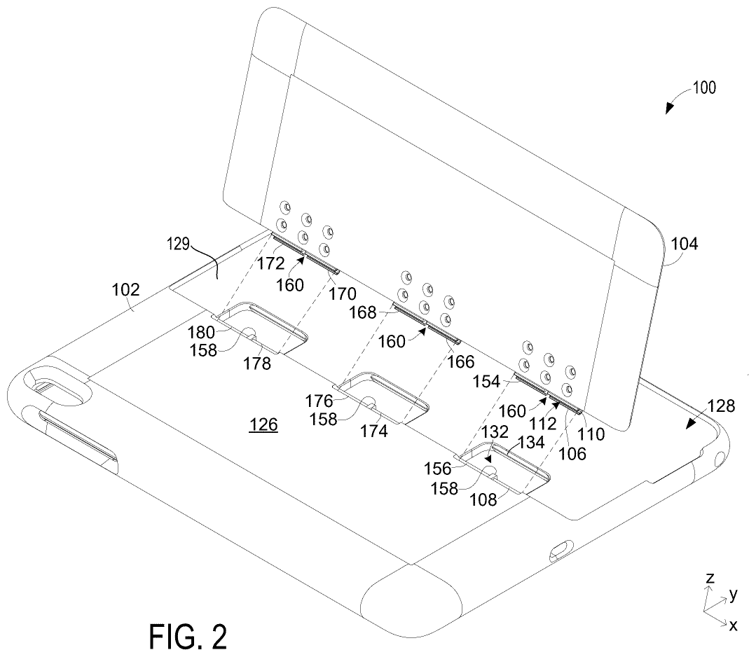

As shown in FIG. 2, and in one potential advantage of the present disclosure, the kickstand 104 is also removable from the case substrate 102. For example, as introduced above and described in more detail below, the kickstand 104 is configured to separate from the case substrate 102 in response to rotation of the kickstand beyond a disengagement threshold angle to prevent damage to the kickstand or the case substrate.

In the present example and as described further below, the kickstand 104 is removably and rotatably coupled to the case substrate 102 via a plurality of friction clips 106, 154, 166, 168, 170, and 172 and corresponding friction clip mounts 108, 156, 174, 176, 178 and 180. In other examples, cases of the present disclosure can utilize a single friction clip and corresponding friction clip mount, or any number of friction clips and friction clip mounts. In the present example, the following description of friction clip 106 and corresponding friction clip mount 108 is applicable to the other friction clips 154, 166, 168, 170, and 172 and corresponding friction clip mounts 156, 174, 176, 178 and 180.

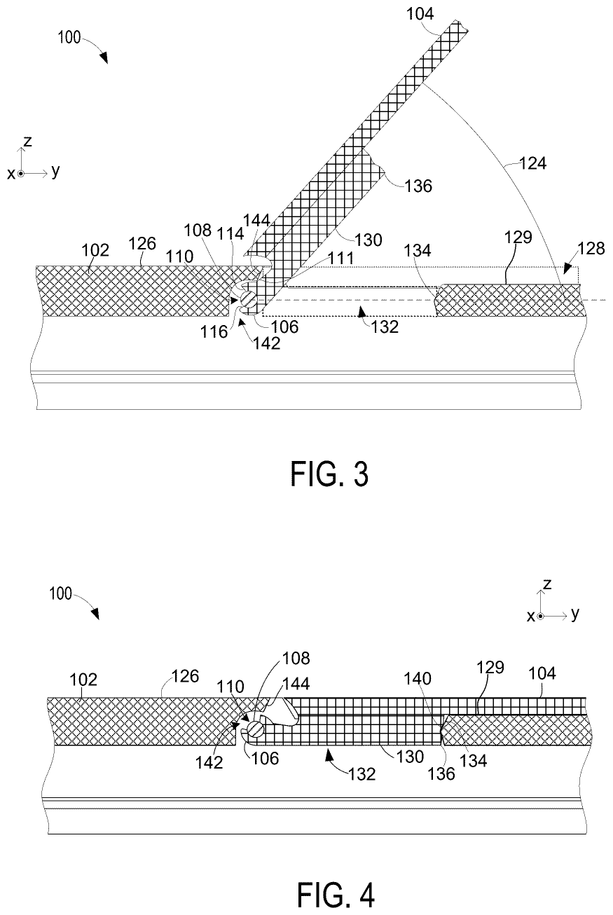

FIG. 3 shows a cross-sectional view of a portion of the case 100 along line 3-3 of FIG. 1. As shown in FIG. 3, in this example the friction clip 106 comprises a partial cylindrical tube. In other examples, the friction clip 106 may comprise any other suitable shape. Other examples of suitable shapes include, but are not limited to, a ball socket and other shapes complementary to a shape of a clip mount to which the friction clip is attached.

In this example, the friction clip 106 partially surrounds a friction clip mount 108 of the case substrate 102 in the form of an elongated cylindrical pin. In the present example, the cylindrical pin extends laterally across the case substrate 102 to form the other friction clip mounts 156, 174, 176, 178 and 180. In other examples, the other friction clip mounts 156, 174, 176, 178 and 180 can be formed from separate pins. In other examples, a friction clip mount may comprise any other suitable shape complementary to a shape of a friction clip to which the friction clip mount is attached. Other examples of suitable shapes include, but are not limited to, spheroids and other shapes complementary to a shape of the friction clip.

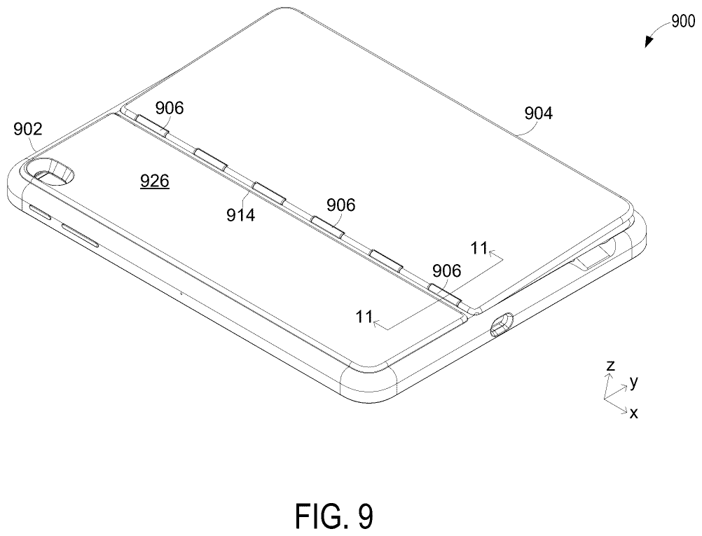

In the present example and with reference also to FIG. 2, the case substrate 102 comprises the friction clip mounts 108, 156, 174, 176, 178 and 180, and the kickstand 104 comprises the friction clips 106, 154, 166, 168, 170, and 172. In other examples, and as described in more detail below with reference to FIGS. 9-13, the case substrate comprises one or more friction clips and the kickstand comprises corresponding friction clip mount(s).

With reference to FIGS. 2, 3, and 5, in this example the friction clip 106 comprises a partial cylindrical tube that defines an opening 110 through which the friction clip mount 108 is attachable to and removable from the friction clip. In this manner, in one potential advantage of the present disclosure and as described further below, when the kickstand 104 is attached to the case substrate 102 via the coupling of the friction clip 106 and the friction clip mount 108, the opening 110 enables the kickstand 104 to be separated from the case substrate 102, thereby reducing the risk of damage to the kickstand and/or case due to over-rotation of the kickstand.

In the example of case 100 and as depicted in FIG. 2, the opening 110 comprises a slot 112 that extends along a length of the partial cylindrical tube comprising the friction clip 106. The friction clip mount 108 resides in the slot 112 when the kickstand 104 is coupled to the case substrate 102. In this manner, the friction clip 106 and the friction clip mount 108 form a hinge having an axis of rotation located at a center point of and extending parallel to the cylindrical pin/friction clip mount. In this manner, the kickstand 104 is rotatable with respect to the case substrate 102 around the longitudinal axis of the friction clip mount 108.

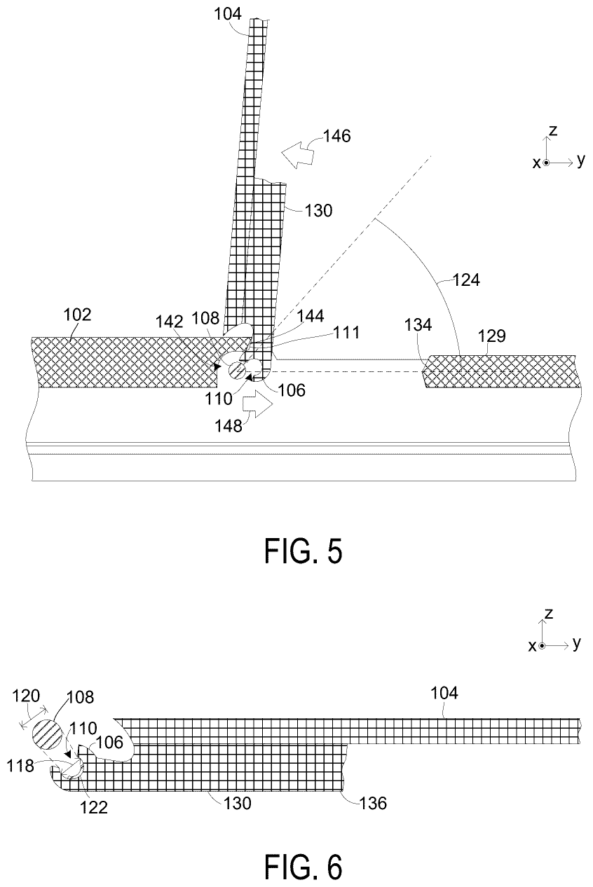

More particularly, as schematically illustrated in the examples of FIGS. 3-4 and described in more detail below, in this example the hinge formed by the friction clip 106 and the friction clip mount 108 cooperates with a leading edge 144 of the case substrate 102 to permit the kickstand 104 to rotate to a disengagement threshold angle 124 of approximately 75 degrees between a closed configuration (FIG. 4) and an open configuration (FIG. 3). Additionally, in another potential advantage of the present disclosure and as described in more detail below with reference to FIG. 5, rotation of the kickstand 104 to an angle greater than the disengagement threshold angle 124 causes the kickstand 104 to separate from the case substrate 102. Advantageously, this prevents damage to the kickstand 104 and/or the case substrate 102 that could occur due to overextension of the kickstand. In other examples and configurations of cases according to the present disclosure, other disengagement threshold angles can be utilized. For example, the kickstand 104 can be rotatable relative to the rear surface 126 of the case substrate 102 to a disengagement threshold angle of up to 45 degrees, up to 60 degrees, up to 90 degrees, up to 120 degrees, or other angle of less than 180 degrees.

With continued reference to FIG. 3, the kickstand 104 is operatively configured to be coupled to the case substrate 102 by snapping the friction clip 106 onto the friction clip mount 108. In some examples, the friction clip 106 comprises beveled edges 114, 116 adjacent to the opening 110. In another potential advantage of the present disclosure, the beveled edges 114, 116 are configured to guide the friction clip 106 over the friction clip mount 108 through the opening 110 and into slot 112, thereby enabling a user to easily align and snap the friction clip onto the elongated pin of the friction clip mount to attach the kickstand 104 to the case substrate 102.

As depicted in FIG. 6, which shows an exploded view of the friction clip 106 and the friction clip mount 108, the slot 112 has an internal diameter 118 that is less than a diameter 120 of the cylindrical pin of friction clip mount 108 when the pin is not located within the slot. Additionally, the friction clip 106 is fabricated a material having some measure of flexibility that enables the friction clip to expand to receive the friction clip mount 108 and form a rotatable engagement embodying a frictional resistance to rotation. Some examples of suitable materials for friction clip 106 include, but are not limited to, acrylonitrile butadiene styrene (ABS), polycarbonate, spring steel, and glass-filled polymers. In this manner, the friction clip 106 can undergo elastic deformation that allows the friction clip mount 108 to pass through the opening 110 and be retained within the slot 112.

As the friction clip 106 is undersized relative to the diameter of the friction clip mount 108, the friction clip 106 exerts a force on the friction clip mount 108 that resists rotation of the kickstand 104 relative to the case substrate 102. In different examples, the internal diameter 118 of the slot 112 and the external diameter 120 of the friction clip mount 108 are configured to provide a magnitude of frictional engagement that enables the kickstand 104 to remain in an angular orientation set by a user, and correspondingly resist rotation under the weight of the computing device housed within the case substrate 102, while also allowing the user to reposition the kickstand by applying a relatively small magnitude of torque, such as approximately 2.0 Newton meters (Nm). Accordingly, the internal diameter 118 of the slot 112 and the external diameter 120 of the friction clip mount are configurable to provide the case with a suitably stiff or loose hinge for an end-user application.

In some examples, a supplemental frictional component is utilized in the slot 112. In the example of FIG. 6, a friction band 122 is molded into the friction clip 106. The friction band 122 at least partially covers an internal surface of the slot 112, such that the friction band 122 is in contact with the friction clip mount 108 when the friction clip mount is seated within the friction clip. The friction band 122 is configured to generate additional friction and resistance to rotation between the friction clip 106 and the friction clip mount 108. Accordingly, and in one potential advantage of this example, the friction band 122 enables the setting of a desired frictional resistance to rotation in a structurally efficient manner, as the friction band occupies a relatively small additional structural volume.

The friction band 122 optionally comprises a different material than the friction clip 106. Some examples of suitable materials for the friction band 122 include, but are not limited to, rubber and other polymers having a suitably high coefficient of friction to resist rotation about the friction clip mount 108. In other examples, the friction band 122 comprises the same material as the friction clip 106.

In some examples, the friction band 122 and the friction clip 106 are molded together as a unitary part. In other examples, the friction band 122 and the friction clip 106 comprise separate parts that are attached together while fabricating the friction clip 106. In this manner, the friction band 122 further reduces the internal diameter 118 of at least a portion of the friction clip 106 and/or provides additional friction and resistance to rotation between the friction clip and the friction clip mount.

As introduced above with reference to FIGS. 3-5, the kickstand 104 is rotatable through a range of angular orientations with respect to the case substrate 102. In some examples, the kickstand 104 is flush with the rear surface 126 of the case substrate 102 when an angle between the kickstand 104 and the case substrate 102 is zero degrees (e.g., the kickstand is in a closed configuration), as depicted in the example of FIG. 4. In such examples, the kickstand 104 is configured to reside in a recessed portion 128 of the case substrate 102 adjacent to a recessed surface 129 when the kickstand is in the closed configuration (See also FIGS. 2 and 3). In this manner, the kickstand 104 can be completely stowed within the case substrate 102 such that it does not protrude past the rear surface 126. Accordingly, in other potential advantages of the present disclosure, in this stowed orientation the kickstand 104 is protected from damage that could occur from impacts to protruding parts, the case 100 is easy and comfortable for a user to handle, store, and transport, and unintentional deployment of the kickstand (e.g., by snagging the kickstand on an object) is prevented.

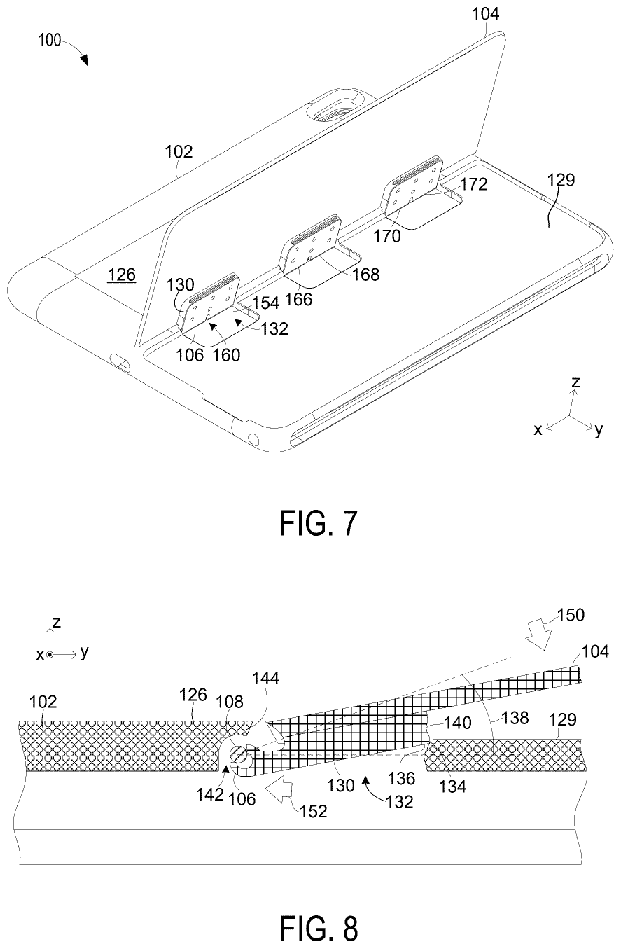

With reference to FIGS. 2-4 and 7, the kickstand 104 includes a friction clip support structure 130 that extends from the friction clip 106. The case substrate 102 also includes an aperture 132 defined in the recessed surface 129 and configured to receive the friction clip support structure 130 when the kickstand 104 is rotated into the closed configuration of FIG. 4. FIG. 7 shows another view of the case 100 illustrating the spatial relationship between the friction clip support structure 130 and the aperture 132. FIG. 7 depicts the kickstand 104 attached to the case substrate 102 in an open configuration. In the closed configuration depicted in the example of FIG. 4, at least a portion of the friction clip support structure 130 is located within the aperture 132. This enables the kickstand to be stowed within the case substrate 102 as described above.

With reference now to FIG. 8, in this example a portion of the recessed surface 129 of the case substrate 102 forms a ramp 134. The ramp 134 is operatively configured to contact a distal end 136 of the friction clip support structure 130 opposite the friction clip 106 when a user is reattaching the kickstand 104 and friction clip to the friction clip mount 108. More particularly, when a user inserts the friction clip support structure 130 and friction clip 106 within the aperture 132, the ramp 134 is operatively configured to urge the friction clip 106 toward the friction clip mount 108 when the kickstand 104 is rotated to an angle less than an engagement threshold angle 138 with respect to the case substrate 102. As the kickstand 104 is rotated in the direction of arrow 150 towards the closed configuration, the distal end 136 contacts the ramp 134 which moves the friction clip 106 in the direction of arrow 152 to snap the friction clip onto the friction clip mount 108. Accordingly, and in another potential advantage of the present disclosure, this configuration enables a user to easily attach the kickstand 104 to the case substrate 102 and ensures that the friction clip 106 engages with the friction clip mount 108 each time the kickstand is attached.

In this example the distal end 136 of the friction clip support structure 130 defines a detent 140. The detent 140 is complementary to a shape of the ramp 134. In this manner, the detent 140 is operatively configured to cooperate with the ramp 134 to secure the kickstand 104 in the closed configuration, as depicted in the example of FIG. 4. Accordingly, and in another potential advantage of the present disclosure, utilizing the detent 140 and corresponding ramp 134 enables the kickstand 104 to be securely retained in the closed configuration without using magnets, clips, or other additional attachment mechanisms.

As shown in FIGS. 3-5 and 8, in some examples the case substrate 102 defines a recessed concavity 142 adjacent to the aperture 132. The recessed concavity 142 is opposite the ramp 134 and extends under the rear surface 126 of the case substrate 102. The friction clip mount 108 is located within the recessed concavity 142. In this manner, the concavity 142 is configured to accommodate the friction clip 106 when the kickstand 104 is coupled to the case substrate 102. Accordingly, and in another potential advantage of the present disclosure, by locating the friction clip mount 108 within the recessed concavity 142, configurations of the present disclosure protect the friction clip mount and attached friction clip 106 from external contact and/or foreign material or debris, along with hiding at least portions of the friction clip mount and attached friction clip from view.

With continued reference to FIGS. 3-5 and 8, the case substrate 102 further comprises a leading edge 144 adjacent to the recessed concavity 142. As shown in FIG. 3, a neck 111 of the kickstand 104 is configured to contact the leading edge 144 when the kickstand 104 is rotated to the disengagement threshold angle 124. In this manner, the configuration and placement of the leading edge 144 may define the angle beyond which rotation of the kickstand 104 causes the friction clip 106 to disengage from the friction clip mount 108. Additionally, and in another potential advantage of the present disclosure, the leading edge 144 further protects the friction clip mount and attached friction clip 106 from external contact and/or foreign material or debris, along with hiding at least portions of the friction clip mount and attached friction clip from view.

Further, the leading edge 144 is operatively configured to disengage the friction clip from the friction clip mount when the kickstand is rotated to an angle greater than the disengagement threshold angle 124 with respect to the case substrate. For example, and as depicted in FIG. 5, the neck 111 of kickstand 104 is leveraged against the leading edge 144 such that applying additional force to continue to rotate the kickstand 104 away from the case substrate 102, as indicated at 146, urges the friction clip 106 away from the friction clip mount 108, as indicated at 148. This causes the friction clip 106 to detach from the friction clip mount 108, thus separating the kickstand 104 from the case substrate 102.

As depicted in FIG. 3, the opening 110 in the friction clip 106 faces into the recessed concavity 142 when the kickstand is oriented at the disengagement threshold angle 124. In this manner, the friction clip 106 can disengage from the friction clip mount 108 when urged away from the friction clip mount by the force created by the leading edge 144 in the y-axis direction. In this manner, the kickstand 104 is configured to separate from the case substrate 102 in response to pressuring the kickstand 104 to rotate past the disengagement threshold angle 124.

In some examples and as noted above, the kickstand 104 comprises two or more friction clips and two or more corresponding friction clip mounts. In some configurations, such as the example shown in FIGS. 1-8, utilizing multiple friction clips and friction clip mounts enables the kickstand 104 to be mounted to the case substrate 102 with additional strength and stability as compared to the use of a single friction clip and friction clip mount. In addition, providing a plurality of smaller friction clips can enable a user to connect the kickstand 104 to the case substrate 102 more easily as compared to providing a single, larger friction clip.

With reference now to FIG. 2, in this example each friction clip mount 108, 174, 178 is separated from an adjacent friction clip mount 156, 176, 180, respectively, by a friction clip mount support 158. Correspondingly, on the kickstand 104 each friction clip 106, 166, 170 is separated from an adjacent friction clip 154, 168, 172, respectively, by a gap 160. The gaps 160 are configured to accommodate the friction clip mount supports 158 when the friction clips 106, 154, 166, 168, 170, and 172 are rotatably attached to their corresponding friction clip mounts 108, 156, 174, 176, 178 and 180. In another potential advantage of the present disclosure, the friction clip mount supports 158 enhance the strength and rigidity of the friction clip mounts that extend through the supports. For example, where the friction clip mounts 108, 156, 174, 176, 178 and 180 are a single elongated cylindrical pin, the friction clip mount supports 158 provide structural integrity to the pin to facilitate durability and extended duty cycles of attaching and detaching the kickstand. The friction clip mount supports 158 also can cooperate with the gaps 160 to assist a user in attaching the kickstand 104 by guiding the friction clips 106, 154, 166, 168, 170, and 172 onto their corresponding friction clip mounts 108, 156, 174, 176, 178 and 180.

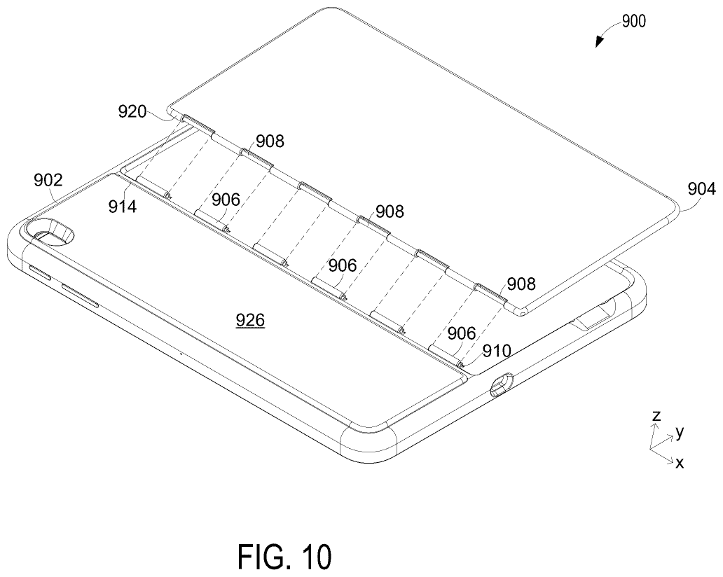

In the examples described above with reference to FIGS. 1-8, the friction clips are located at the kickstand 104 and the friction clip mounts are located at the case substrate 102. FIGS. 9 and 10 show another example of a case 900 for a computing device according to examples of the present disclosure. Like the case 100 of FIGS. 1-8, the case 900 comprises a case substrate 902 and a kickstand 904. In contrast to the case 100 of FIGS. 1-8, the kickstand 904 comprises friction clip mounts 908 and the case substrate 902 comprises friction clips 906 that are configured to partially surround the friction clip mount 908 to removably and rotatably couple the kickstand 904 to the case substrate 902.

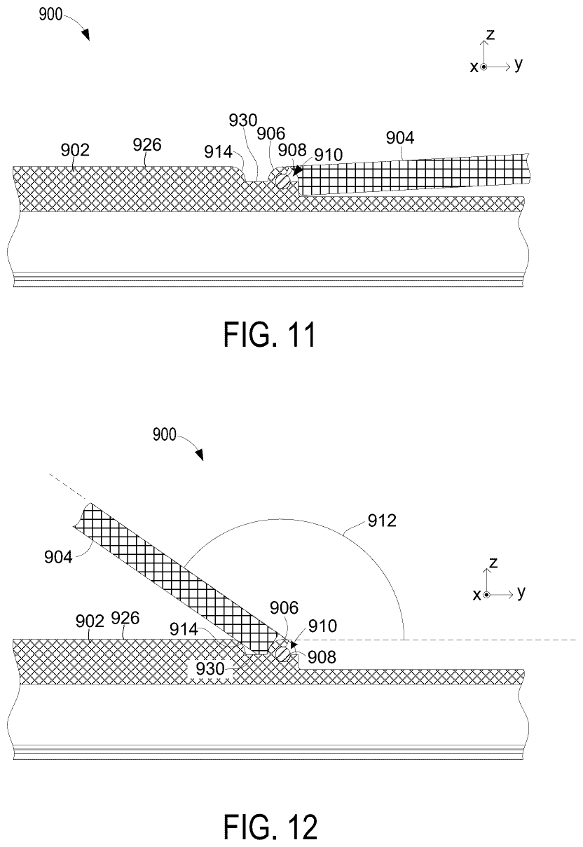

With reference also to FIG. 11, and like the friction clip 106 of the example case 100 depicted in FIGS. 1-8, the friction clips 906 each comprise a partial cylindrical tube. In other examples, the friction clips 906 may comprise any other suitable shape. Other examples of suitable shapes include, but are not limited to, a ball socket and other shapes complementary to a shape of a friction clip mount to which the friction clip is attached.

Like the friction clip mount 108 of the example case 100 depicted in FIGS. 1-8, the friction clip mounts 908 each comprise an elongated cylindrical pin. In the present example, a single cylindrical pin extends laterally across a front edge 920 of the kickstand 904 to form the friction clip mounts 908. In other examples, each of the friction clip mounts 908 is formed from separate cylindrical pins. In other examples, the friction clip mounts 908 may comprise any other suitable shape. Other examples of suitable shapes include, but are not limited to, spheroids and other shapes complementary to a shape of the friction clips 906.

FIG. 11 shows a cross-sectional view of a portion of the case 900 along line 11-11 of FIG. 9. As shown in FIG. 11, the friction clip 906 defines an opening 910 that partially surrounds the friction clip mount 908 to rotatably couple the kickstand 904 to the case substrate 902. In this manner, the friction clip mount 908 is removeable from the friction clip 906 via the opening 910 to thereby separate the kickstand 904 from the case substrate 902. Like the openings 110 in the friction clips of the example case 100 depicted in FIGS. 1-8, each of the openings 910 in friction clips 906 comprises a slot that extends along a length of the partial cylindrical tube of the friction clip.

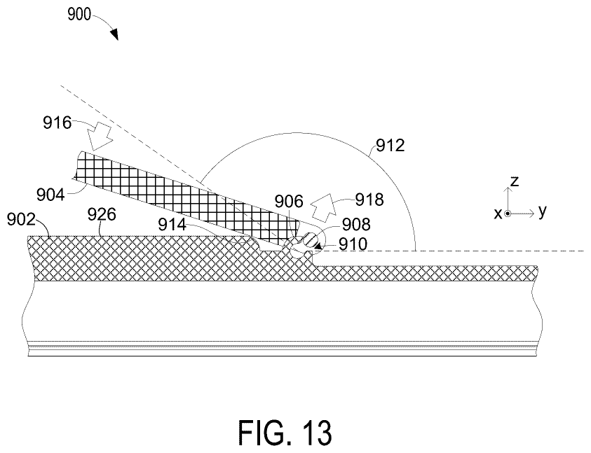

As illustrated by example in FIGS. 12 and 13, and like the kickstand 104 of FIGS. 1-8, the kickstand 904 is configured to separate from the case substrate 902 upon rotation of the kickstand 904 beyond a disengagement threshold angle 912 between the kickstand 904 and the case substrate 902. This prevents damage to the kickstand or the case substrate that could occur due to overextension of the kickstand.

The case substrate 902 further comprises a surface relief feature 914. The surface relief feature 914 is operatively configured to disengage the friction clip 906 from the friction clip mount 908 when the kickstand 904 is rotated to an angle greater than the disengagement threshold angle 912. In the example depicted in FIGS. 9-13, the surface relief feature 914 extends laterally in the x-axis direction across a width of a rear surface 926 of the case substrate 902. With reference to FIGS. 11 and 12, the surface relief feature 914 abuts a trough 930 formed by the surface relief feature and the friction clip 906. The surface relief feature 914 is positioned proud of the trough 930, and the trough provides space for the kickstand 904 to rotate to the disengagement threshold angle 912. In this manner, the surface relief feature 914 is operatively configured to contact the kickstand 904 when the kickstand is rotated to and beyond the disengagement threshold angle 912. In this manner and in different configurations, the placement of the surface relief feature 914 can be utilized to define the disengagement threshold angle beyond which rotation of the kickstand 904 causes the friction clip 906 to disengage from the friction clip mount 908.

In the example of FIGS. 12 and 13, the kickstand 904 is leveraged against the surface relief feature 914 in a manner similar to the kickstand 104 and the leading edge 144 of FIG. 5. In this manner, applying additional force to continue to rotate the kickstand 904 beyond the disengagement threshold angle 912, as indicated at 916, urges the friction clip mount 908 away from the friction clip 906, as indicated at 918. This causes the friction clip mount 908 to detach from the friction clip 906, thus separating the kickstand 904 from the case substrate 902.

In this configuration, the opening 910 in the friction clip 906 faces away from the surface relief feature 914 of the case substrate 102. In this manner, the friction clip mount 908 can disengage from the friction clip 906 when urged away from the friction clip by the force leveraged against the surface relief feature 914. In this manner, the kickstand 904 is configured to separate from the case substrate 902 in response to rotating the kickstand past the disengagement threshold angle.

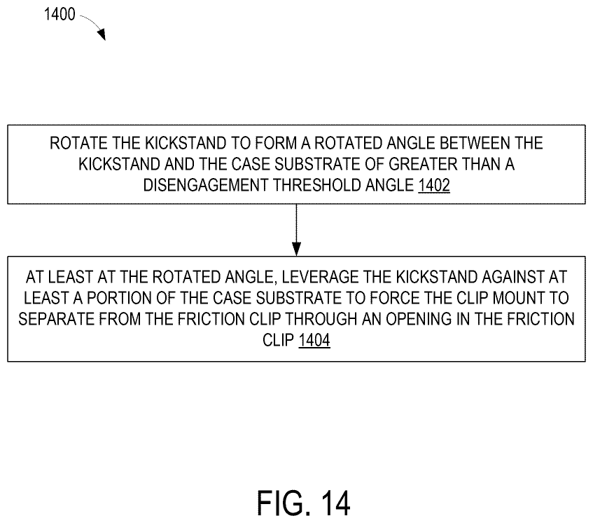

With reference now to FIG. 14, a method 1400 is provided for detaching a kickstand that is removably and rotatably coupled to a case substrate for a computing device via a friction clip that partially surrounds a friction clip mount of the case substrate. The following description of the method 1400 is provided with reference to the components described above. For example, the method 1400 may be performed using the case 100 of FIGS. 1-8. It will also be appreciated that the method 1400 also may be performed in other contexts using other suitable components.

At 1402, the method 1400 comprises rotating the kickstand to form a rotated angle between the kickstand and the case substrate of greater than a disengagement threshold angle. For example, the kickstand 104 of FIGS. 3 and 5 is rotated to a rotated angle greater than the disengagement threshold angle 124.

The method 1400 further comprises, at 1404, at least at the rotated angle, leveraging the kickstand against at least a portion of the case substrate to force the friction clip mount to separate from the friction clip through an opening in the friction clip. For example and as shown in FIG. 5, as the kickstand is rotated past the disengagement threshold angle 124 to the rotated angle, the kickstand 104 is leveraged against the leading edge 144 of the case substrate 102 to cause the friction clip 106 to detach from the friction clip mount 108, thus separating the kickstand 104 from the case substrate 102.

The above-described apparatuses and methods may be used to enable a kickstand to rotate and to support the weight of at least a portion of a computing device. The kickstand is also removable from the case and is configured to disengage in response to being rotated beyond a disengagement threshold angle. This enables the kickstand to separate from the case and prevent damage to the kickstand or case substrate.

The following paragraphs provide additional support for the claims of the subject application. One aspect provides a case for a computing device, the case comprising: a case substrate comprising a friction clip mount; and a removeable kickstand comprising a friction clip removably coupled to the friction clip mount, wherein the friction clip defines an opening that partially surrounds the friction clip mount to rotatably couple the kickstand to the case substrate, and the friction clip is removeable from the friction clip mount via the opening to thereby separate the kickstand from the case substrate. In some examples, the friction clip mount additionally or alternatively comprises an elongated cylindrical pin. In some examples, the case substrate additionally or alternatively comprises an external surface, and the case substrate is configured such that the kickstand is flush with the external surface when an angle between the kickstand and the case substrate is zero degrees. In some examples, the kickstand additionally or alternatively comprises a friction clip support structure extending from the friction clip, wherein at least a portion of the friction clip support structure is located within an aperture defined in a recessed surface of the case substrate when the kickstand is in a closed configuration. In some examples, the case substrate additionally or alternatively defines a recessed concavity adjacent to the aperture, and the friction clip mount is located within the recessed concavity. In some examples, the case substrate additionally or alternatively comprises a leading edge adjacent to the recessed concavity, the leading edge operatively configured to contact the kickstand and disengage the friction clip from the friction clip mount when the kickstand is rotated to an angle greater than a disengagement threshold angle with respect to the case substrate. In some examples, a neck of the kickstand is configured to contact the leading edge when the kickstand is rotated to the disengagement threshold angle. In some examples, the opening in the friction clip additionally or alternatively faces into the recessed concavity when the kickstand is oriented at the disengagement threshold angle. In some examples, a portion of the recessed surface of the case substrate additionally or alternatively forms a ramp within the aperture, the ramp operatively configured to contact a distal end of the friction clip support structure and urge the friction clip toward the friction clip mount when the kickstand is rotated to an angle less than an engagement threshold angle with respect to the case substrate. In some examples, the distal end of the friction clip support structure additionally or alternatively defines a detent operatively configured to cooperate with the ramp to secure the kickstand in the closed configuration. In some examples, the friction clip additionally or alternatively comprises a partial cylindrical tube that defines the opening. In some examples, the tube additionally or alternatively defines a slot-like opening that extends along a length of the partial cylindrical tube. In some examples, the case additionally or alternatively comprises a friction band molded into the friction clip. In some examples, the kickstand additionally or alternatively comprises two or more friction clips, and wherein each friction clip of the two or more friction clips is separated from an adjacent friction clip by a gap. In some examples, the case substrate additionally or alternatively comprises two or more friction clip mounts, and wherein each friction clip mount of the two or more friction clip mounts is separated from an adjacent friction clip mount by a friction clip mount support.

Another aspect provides a case for a computing device, the case comprising: a removable kickstand comprising a friction clip mount; and a case substrate comprising: a friction clip removably coupled to the friction clip mount of the removable kickstand, the friction clip defining an opening that partially surrounds the friction clip mount to rotatably couple the kickstand to the case substrate, the friction clip mount being removeable from the friction clip via the opening to thereby separate the kickstand from the case substrate; and a surface relief feature operatively configured to disengage the friction clip from the friction clip mount when the kickstand is rotated to an angle greater than a disengagement threshold angle between the kickstand and the case substrate. In some examples, the surface relief feature comprises a projection that protrudes from an end of the rear surface of the case substrate. In some examples, the surface relief feature is positioned above a trough that is located between the surface relief feature and the friction clip. In some examples, the friction clip mount additionally or alternatively comprises an elongated cylindrical pin. In some examples, the friction clip additionally or alternatively comprises a partial cylindrical tube that defines the opening. In some examples, the tube additionally or alternatively defines a slot-like opening that extends along a length of the partial cylindrical tube. In some examples, the opening in the friction clip additionally or alternatively faces away from the surface relief feature of the case substrate.

Another aspect provides a method for detaching a kickstand removably and rotatably coupled to a case substrate for a computing device via a friction clip that partially surrounds a friction clip mount of the case substrate, the method comprising: rotating the kickstand to form a rotated angle between the kickstand and the case substrate of greater than a disengagement threshold angle; and at least at the rotated angle, leveraging the kickstand against at least a portion of the case substrate to force the friction clip mount to separate from the friction clip through an opening in the friction clip.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A case for a computing device, the case comprising:
a case substrate comprising a friction clip mount located within a recessed concavity, and a leading edge provided adjacent to the recessed concavity; and
a removeable kickstand comprising a friction clip removably coupled to the friction clip mount, wherein the friction clip defines an opening that partially surrounds the friction clip mount to rotatably couple the kickstand to the case substrate, and the friction clip is removeable from the friction clip mount via the opening to thereby separate the kickstand from the case substrate;
wherein the leading edge is operatively configured to contact the kickstand and disengage the friction clip from the friction clip mount when the kickstand is rotated to an angle greater than a disengagement threshold angle with respect to the case substrate.

2. The case of claim 1, wherein the friction clip mount comprises an elongated cylindrical pin.

3. The case of claim 1, wherein the case substrate comprises an external surface, and the case substrate is configured such that the kickstand is flush with the external surface when an angle between the kickstand and the case substrate is zero degrees.

4. The case of claim 1, wherein the kickstand further comprises a friction clip support structure extending from the friction clip, wherein at least a portion of the friction clip support structure is located within an aperture defined in a recessed surface of the case substrate when the kickstand is in a closed configuration.

5. The case of claim 4, wherein the recessed concavity is adjacent to the aperture.

6. The case of claim 1, wherein the opening in the friction clip faces into the recessed concavity when the kickstand is oriented at the disengagement threshold angle.

7. The case of claim 1, wherein a portion of the recessed surface of the case substrate forms a ramp within the aperture, the ramp operatively configured to contact a distal end of the friction clip support structure and urge the friction clip toward the friction clip mount when the kickstand is rotated to an angle less than an engagement threshold angle with respect to the case substrate.

8. The case of claim 7, wherein the distal end of the friction clip support structure defines a detent operatively configured to cooperate with the ramp to secure the kickstand in the closed configuration.

9. The case of claim 1, wherein the friction clip comprises a partial cylindrical tube that defines the opening.

10. The case of claim 9, wherein the tube defines a slot-like opening that extends along a length of the partial cylindrical tube.

11. The case of claim 1, further comprising a friction band molded into the friction clip.

12. The case of claim 1, wherein the kickstand comprises two or more friction clips, and wherein each friction clip of the two or more friction clips is separated from an adjacent friction clip by a gap.

13. The case of claim 1, wherein the case substrate comprises two or more friction clip mounts, and wherein each friction clip mount of the two or more friction clip mounts is separated from an adjacent friction clip mount by a friction clip mount support.

14. A case for a computing device, the case comprising:
a removable kickstand comprising a friction clip mount; and
a case substrate comprising:
a friction clip removably coupled to the friction clip mount of the removable kickstand, the friction clip defining an opening that partially surrounds the friction clip mount to rotatably couple the kickstand to the case substrate, the friction clip mount being removeable from the friction clip via the opening to thereby separate the kickstand from the case substrate; and
a surface relief feature operatively configured to disengage the friction clip from the friction clip mount when the kickstand is rotated to an angle greater than a disengagement threshold angle between the kickstand and the case substrate.

15. The case of claim 14, wherein the friction clip mount comprises an elongated cylindrical pin.

16. The case of claim 14, wherein the friction clip comprises a partial cylindrical tube that defines the opening.

17. The case of claim 16, wherein the tube defines a slot-like opening that extends along a length of the partial cylindrical tube.

18. The case of claim 14, wherein the opening in the friction clip faces away from the surface relief feature of the case substrate.

19. A method for detaching a kickstand removably and rotatably coupled to a case substrate for a computing device via a friction clip that partially surrounds a friction clip mount of the case substrate, the method comprising:
rotating the kickstand to form a rotated angle between the kickstand and the case substrate of greater than a disengagement threshold angle; and
at least at the rotated angle, leveraging the kickstand against at least a portion of the case substrate to force the friction clip mount to separate from the friction clip through an opening in the friction clip.

20. The case of claim 14, wherein the removable kickstand comprises a plurality of friction clip mounts, and the case substrate comprises a plurality of corresponding friction clips removably coupled to one of the friction clip mounts.
